(19) United States
(12) Patent Application Publication
(10) Pub. No.: US 2014/0235824 A1
(43) Pub. Date: Aug. 21, 2014

(54) Method to Wash Greasy Wool, A Method to Separate Lanolin from the Said Greasy Wool, Wool and Lanolin Obtainable by These Methods

(71) Applicant: ERUTAN BV, Grubbenvorst (NL)

(72) Inventor: Christiaan Matthias Hubertus Gerard Reutelingsperger, Arcen (NL)

(21) Appl. No.: 14/350,129

(22) PCT Filed: Oct. 5, 2012
(86) PCT No.: PCT/EP2012/069680

§ 371 Date: Apr. 7, 2014

(30) Foreign Application Priority Data
Oct. 7, 2011 (EP) 11184427.0

(51) Int. Cl. D01C 3/00; C11B 11/00

(52) U.S. Cl. CPC D01C 3/00; C11B 11/005
USPC 530/357; 8/139; 435/263; 552/544

(57) ABSTRACT

A method to wash wool containing lanolin and impurities includes the steps of providing a volume of an aqueous liquid at a temperature below a melting temperature of the lanolin, soaking the wool in the volume of the liquid, creating air bubbles in the liquid and allowing the air bubbles to pass through the wool to attach the impurities, removing the air bubbles and attached impurities from the volume, and separating lanolin from wool containing lanolin and impurities, along with the wool and lanolin obtainable by this method.

### FIELD OF THE INVENTION

The present invention pertains to the washing of greasy wool, i.e. wool still containing lanolin (wool fat) and impurities. The invention also pertains to a method to extract the lanolin from the said wool and to wool and lanolin obtainable by said methods.

### BACKGROUND OF THE INVENTION

Wool straight off a sheep (i.e. wool which has not yet undergone a treatment to substantially remove the wool grease), also known as “greasy wool” or “wool in the grease”, contains lanolin (also referred to as wool grease, wool fat or Adeps Lanae) and impurities such as e.g. dirt, dead skin, sweat residue (particularly salts; also referred to as “suint”), potentially pesticides (depending on the origin of the wool), and vegetable matter. The lanolin and the impurities, as far as present, need to be removed before the wool can be processed further to be used e.g. as a material for the production of textiles. Lanolin, which melts around 38-44° C., is a very complex mixture comprising esters of various long-chain fatty acids with long-chain alcohols and sterols. It has been estimated that there may be between 8,000 and 20,000 different types of esters present in lanolin resulting from combinations between the ca. 200 different lanolin acids and the ca. 100 different lanolin alcohols that have been identified. Lanolin is devoid of glycerides and thus technically it is a wax, not a fat. Refined lanolin (the product resulting from deodorisation, decolourisation, neutralisation and removal of entrained water), also referred to as “anhydrous lanolin”, is an important item of commerce, widely used e.g. in cosmetic products such as hand creams. It is noted that in the pharmaceutical industry the term lanolin is used for a water-in-oil emulsion with a water content of approximately 30% in weight. In the present application, the term lanolin is used for the wax itself.

As stated above, before wool can be used for commercial purposes, the lanolin and impurities have to be removed. This washing process is called scouring, a process of cleaning the greasy wool. Traditional small scale wool scouring takes place by simply bathing the wool in warm water (above the melting temperature of lanolin), optionally using detergents. This way the lanolin is removed together with the dirt, suint, vegetable matter etc. as one dirty effluent. In modern scouring plants, scouring is a complicated industrial process using warm water, detergent, often alkali, and specialized equipment. In commercial wool, vegetable matter is sometimes removed by chemical carbonization but this leads to loss of the high value lanolin. In less processed wools, vegetable matter may be removed by hand, and some of the lanolin may then be left intact through use of gentler detergents. This process however is not economically attractive since at lot of the lanolin remains on the wool.

In particular, in an industrial souring process widely used to scour wool, the wool passes through a series of bowls, each separated from the next by large pressurised squeeze rollers. Typically there are six bowls, of which the first three are the actual scouring bowls. These bowls contain hot water at a temperature above the melt-temperature of lanolin to make sure the lanolin is removed from the wool. These three bowls typically have a temperature of about 60-65° C., contain detergent at about 1-3 g/l, and optionally contain one or more alkalis (usually solely sodium carbonate). The next two bowls are cold rinse bowls and the final bowl is a hot (60-65° C.) rinse bowl. Liquor from the first, most contaminated bowl is cycled through dirt and lanolin removal equipment, after which some, typically 1 liter/kg greasy wool is run to drain. This loss of liquor from the first bowl is made up with liquor from the second bowl and so on. The amount of wool a single sour train can process depends on the width of the train. The range is typically about 0.6-5 tonnes of greasy wool per hour.

### OBJECT OF THE INVENTION

The known industrial process is fast (typically it takes less then a few minutes) but has an important disadvantage: The scoured wool, even after drying typically has a more or lesser pronounced “stable-odor”, meaning that it smells a bit like a mixture of a stable interior, dirt, manure, animal food, a bit of “farm”, the outdoors and/or the animal where it originates from. Some people like this smell since it gives wool a natural aura. However, for many high end applications such as business and design clothing, carpets and upholstery this odor or smell is unwanted. Therefore, often selection of the least smelly wool takes place for such high end applications.

It is an object of the invention to provide a method to wash greasy wool, i.e. wool containing lanolin and impurities, wherein the problem of stable-odor of the wool is prevented or at least substantially mitigated, thus leading to wool that has no or a substantive less stable-odor than when washed with present day scouring processes. It is another object of the invention to provide a new method to wash greasy wool, the method being suitable for application on a commercial scale.

### SUMMARY OF THE INVENTION

In order to meet an object of the invention, a method has been devised wherein a volume of an aqueous liquid at a temperature below a melting temperature of the lanolin present in the wool is provided, soaking the wool in the volume of the liquid, creating air bubbles in the liquid (the term “creating” also covers the mere introduction in the said liquid of remotely produced air bubbles) and allowing the air bubbles to pass through the wool to attach the impurities, and finally removing the wool from the said volume. Optionally, the aqueous liquid comprises one or more detergents or other additives such as for example preservatives, stabilizers, wool improvement compounds etc. After washing the wool, the wool is typically dried and baled.

Applicant found that the stable odor and impurities can be removed from the wool by this process, simply by leading air bubbles through the soaked wool, even at a temperature where the lanolin remains as a solid wax on the wool fibres. This method uses the common knowledge that differential wetting of impurities may lead to attachment of these impurities to air bubbles, which can easily removed from a volume of liquid. This common knowledge has been the basis for so called flotation techniques, which have been used for decades already in order to remove impurities from various compounds. It came as a great surprise however that the impurities can be removed from the wool while the lanolin remains as a solid substance on the wool fibres and also, that the washed wool may have a far less or even no stable-odor when compared with prior art industrial wool wash methods. The reason for this is not clear but may be attributable to the fact that the outer layer of the wool (the cuticle) remains closed at lower temperatures.

Apart from the above, the present invention provides other advantages. The new method for example can be performed at a substantial lower washing liquid temperature, typically at least about 20-25° C. lower (viz. less than about 38-44° C. versus 60-65° C. for prior art methods), which corresponds to substantial energy savings. Another advantage of the present method is that the impurities derived from the greasy wool when attached to the air bubbles, do not, or at least hardly, contain lanolin. This means that the impurities, which in essence contain salts, may be used directly in applications were salts are used, e.g. as an artificial fertilizer (when no pesticides are present).

It is noted that it has been known a long time to treat scour effluent with flotation techniques to remove impurities from the effluent. However, wool itself is traditionally scoured above a melting temperature of lanolin to make sure the lanolin is removed from the wool during the washing step. And even where the prior art suggest or shows that washing of greasy wool can take place below a melting temperature of lanolin, there is no disclosure of a flotation-like technique to remove impurities such as dirt, suint, vegetable matter, pesticides etc. from the wool.

Another advantage of the present method is that the lanolin, a valuable item of commerce, does not need to be extracted from a scouring effluent that contains a mixture of lanolin, dirt, suint, vegetable material and possible other impurities. The present invention enables that lanolin can be separated from washed, clean wool. Also, the fact that the washed wool may have no or substantial less stable-odor, means that the lanolin that remains on the washed wool in the present method is also effectively, at least to a substantial part, deodorized. The current invention thus also pertains to a method to separate lanolin from wool containing lanolin and impurities, comprising proving a volume of an aqueous liquid at a temperature below a melting temperature of lanolin present in the wool, soaking the wool in the volume of the liquid, creating air bubbles in the liquid and allowing the air bubbles to pass through the wool to attach impurities, leaving the lanolin on the wool, and thereafter and separating the lanolin from the wool.

The fact that with the present method the lanolin can be easily separated from the washed and, at least partly, deodorized wool, and does not need to be separated from an effluent scour containing large amounts of impurities, effectively means that the yield of obtained lanolin per weight amount of wool may be doubled, from approximately 1.5% to about 3%.

The present invention also pertains to wool obtainable by any of the methods according to the invention. When compared with wool obtainable by prior art methods, this wool has no or a substantially less stable-odor. The same is true for the lanolin obtainable by the method described supra.

### DEFINITIONS

Wool: a fibrous material consisting essentially of the protein keratin. The length of the fibres usually ranges from 3 to 40 centimetres depending on the animal source (sheep, camel, goat, rabbit, lama, muskoxen, vicuña, alpaca etc). Each fibre in the wool is made up of three essential components: the cuticle, the cortex, and the medulla. The cuticle is the outer layer. It is a protective layer of scales arranged like shingles or fish scales. When two fibres come in contact with each other, these scales tend to cling and stick to each other. It's this physical clinging and sticking that allows wool fibres to be spun into thread so easily. The cortex is the inner structure made up of millions of cigar-shaped cortical cells. In natural-coloured wool, these cells contain melanin. The arrangement of these cells is also responsible for the natural crimp unique to wool fibre. The medulla may comprise a series of cells (similar to honeycombs) that provide air spaces, giving wool its thermal insulation value. Wool, like residential insulation, is effective in reducing heat transfer.

Lanolin: wool fat, a mixture consisting mostly of esters of various long-chain fatty acids with long-chain alcohols and sterols, having a melting temperature between approximately 38-44° C., depending La. on the origin of the wool.

Flotation: The process of separating different materials by agitating a composition of the materials with an aqueous liquid (such as water) while passing air bubbles (the term “air” in this patent specification includes any gas suitable for use in a floatation(-like) process, such as nitrogen, neon, argon, oxygen, mixtures thereof etc.) through the liquid. Differential wetting causes impurities to be carried by the air bubbles to the surface of the liquid for collection.

Aqueous liquid: any liquid that is freely miscible with water, i.e. miscible in any proportion between without spontaneous phase separation visible with the naked human eye.

### EMBODIMENTS OF THE INVENTION

In an embodiment of the wool washing method according to the invention the wool is soaked in the volume of liquid for 1 to 60 minutes, preferably 10-40 minutes, before the air bubbles are allowed to pass through the wool. It has been found that a very good cleaning action can be obtained by firstly soaking the wool in the aqueous liquid. It is believed that this may be due to an adequate differential wetting of the wool and impurities, as well as the solubilizing of any matter that is readily soluble in the aqueous liquid such as for example the water-soluble fraction of the lanolin (e.g. the free alcohols). Typical soaking times are 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 and 40 minutes or any sub-ranges thereof.

In another embodiment the air bubbles and attached impurities are removed from the volume while the wool is being washed, by skimming off the said bubbles when having reached a surface of the said volume of the liquid. In this embodiment a typical flotation set-up is used. This set-up has found to be convenient for the washing method. In a flotation set-up, i.e. a set-up having a container with a steady surface (i.e. a surface that is in essence steady, viz. that remains substantially at the same place; as opposed to a surface that moves constantly such as in a tumbling container of a standard house-hold washing machine) that can be readily skimmed off. Such skimming off can be performed e.g. by allowing an overflow of the container, whereby the air bubbles with attached impurities, which form more or less a foam-like substance, can be very easily removed from the liquid. The liquid that flows over with the foam can be recycled to the container.

In yet another embodiment the wool is agitated when the air bubbles pass through the wool. Agitation has proven to be advantageous to obtain a complete or near complete removal of the impurities. Agitation shortens the time needed to obtain the said removal of the impurities. In a further embodiment the wool is agitated by imposing a flow in the liquid. In an embodiment the flow in the liquid is imposed by the creation of the air bubbles. By creating air bubbles, a flow in the liquid may be created sufficient to agitate the wool. Since air bubbles have to be created in the method anyway, this is a convenient embodiment wherein paddles or other rudder works can be dispensed with. In an alternative embodiment, the flow is created by quickly allowing a large amount of liquid into a far end of the volume of the liquid (for example a far end of a basin wherein the liquid is present), forcing the liquid to even out, thereby generating a sizeable wave and corresponding agitation of the wool (it is noted that this technique is comparable to techniques used to create waves in large swimming pools). The excess liquid may for example be removed by being channeled through a return canal where it can be used again to generate another wave.

In an embodiment the air bubbles are created in the liquid by ejecting a liquid containing air bubbles in the volume using an ejection nozzle. It was found that it is advantageous to eject a liquid containing air bubbles instead of creating air bubbles directly. Air bubbles created directly in the volume of liquid tend to coalesce. Although still capable of attaching impurities, the removal of these impurities by bigger air bubbles is less efficient. By ejecting a liquid containing air bubbles, coalescence has found to take place to a lesser extent. Moreover, with the ejecting nozzles, a precise flow can be created in the volume of liquid.

In yet another embodiment, after washing the wool the lanolin is removed from the wool. This leads to wool that is ideally suitable for high end applications such as the production of floor coverings, upholstery and contemporary clothing.

In a further embodiment, the wool is treated with a protease after the lanolin is removed. It is known that various properties of the wool fibres, such as resistance to shrinking, can be improved by proteolytic treatment of the wool. Applicant found that in combination with the present invention, yet another property of the wool can be improved. In particular, it has been found that the property of wool to turn yellow upon impact of UV radiation such as present in sunlight can be prevented or at least mitigated by enzymatic treatment with proteases modified in a way to be larger and thus not penetrate and destroy wool fibres. Useful examples of such sterically enlarged proteases are known from i.a. from Lenting et al. in the Journal of Biotechnology, 2009 October ; 4(10), 1441-9 and Jus et al. in Enzyme and Microbial Technology (2006; doi:10.1016/j.enzmictec.2006.10.001) and Smith et al. in Enzyme and Microbial Technology 47, 2010, pp. 105-111. It has been found that upon treating the wool washed in line with the current invention with such modified proteases (after the lanolin is removed), the UV resistance to colour change can be significantly improved.

In an embodiment of the method to separate lanolin from greasy wool, the lanolin is separated from the wool by solvent extraction. Solvent extraction appears to be an adequate method to remove lanolin from washed wool. When compared to melting in hot water, it takes substantially less energy. Moreover, the lanolin can more easily be separated from a solvent then from an aqueous liquid, since lanolin has the tendency to from an emulsion with water.

In a further embodiment the wool is removed from the volume of liquid, and preferably dried, before the lanolin is extracted from the wool. This way, the lanolin contains less water and is easy to separate from the wool and later on from the solvent to arrive at a more purer form (less hydrous) of lanolin. This means that in order to arrive at anhydrous lanolin, a high value item of commerce, less or even no water has to be removed from the ultimate lanolin fraction obtained by solvent extraction from the wool.

In yet a further embodiment the solvent is biodegradable, amounting to the environmentally friendly character of the methods according to the present invention. Examples of usable solvents are (cyclo)alkyl alcohols such as ethyl alcohol and benzyl alcohol, or products such as Bio-Solv (available from MAS Products, Cinnaminson, N.J., USA) and BLC-490 (available from Bio-Lub, Trois-Rivières, Quebec, Canada).

In another embodiment the lanolin is separated from the solvent by evaporation of the solvent, preferably using a distillation process. Evaporation is very convenient to separate the lanolin from the solvent. Using commonly applied distillation techniques even further increases convenience, yield, quality of the end-product and ease of recycling the solvent.

The invention will now be further elucidated using the following non-limiting examples.

### EXAMPLES

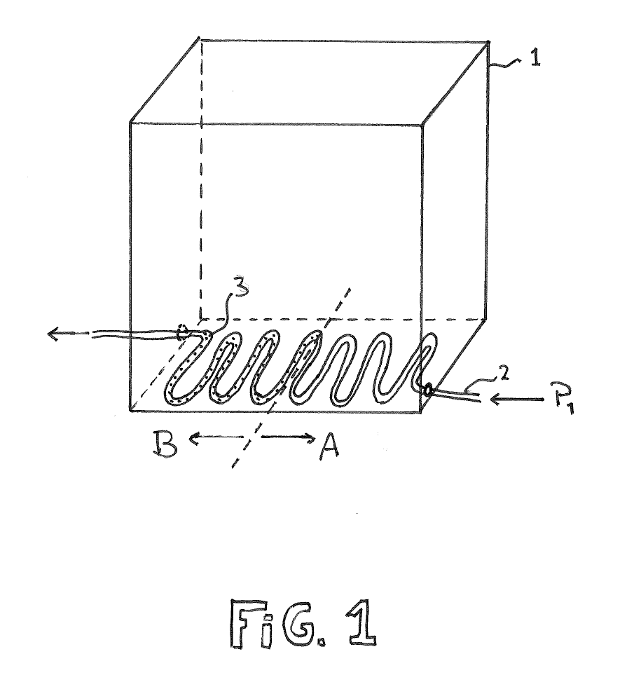

Example 1, in conjunction with FIG. 1 describes a first embodiment of the invention.

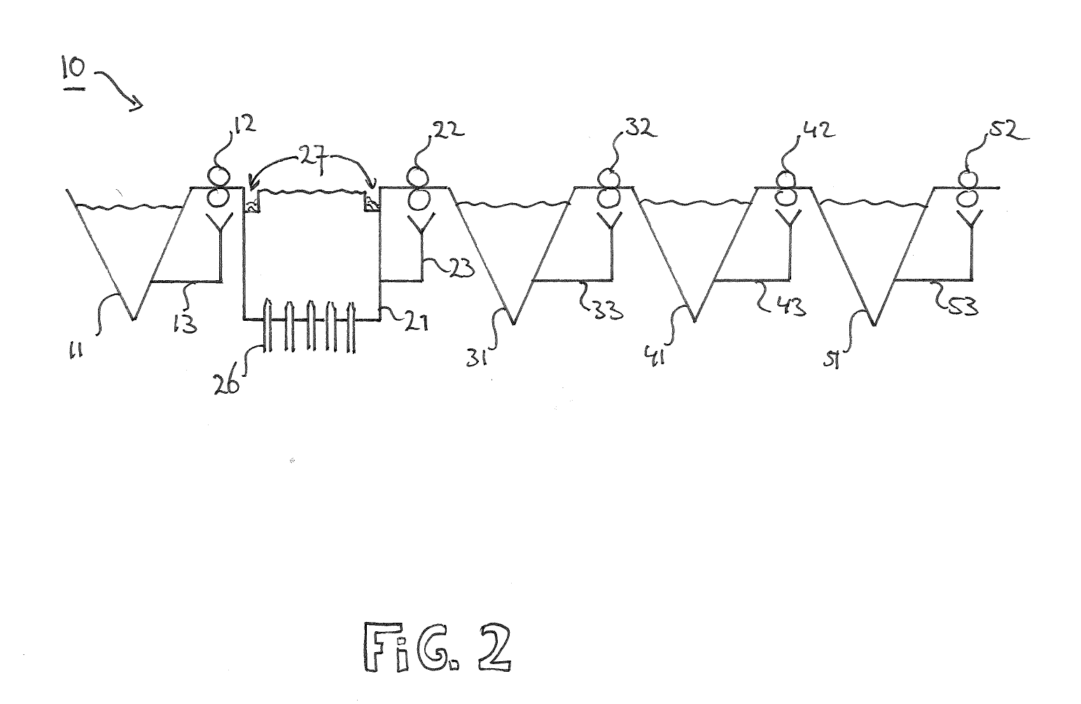

Example 2, in conjunction with FIG. 2 schematically shows a production line for scouring wool and obtaining lanolin in line with the invention.

### EXAMPLE 1

The wool washing method according to the present invention can be performed on a lab-scale in a glass container as depicted in FIG. 1. This container 1 has a front length of 60 cm, a depth of 30 cm and a height of 60 cm. On the bottom of this container lies a polyvinylchloride tube 2 (with a length of about 5 meters), having an outer diameter of 9 mm and an inner diameter of 6 mm. The tube is connected to a pressure source (not shown), being able to provide compressed air (normal atmospheric air) at a pressure P₁ (about 1½-2 bar) at the entrance of the tube. The tube has s first section A, and a second section B. The second section of the tube is provided with small holes (about 0.7 mm² cross section) at a frequency of about 100 holes per meter.

The container is filled to 90% with normal tap water, having a temperature of about 20° C., no detergents or other components are added. Then about 4 kg of greasy wool is soaked into the water and left for 10 minutes, gently moving the wool around by hand to assure complete wetting. Then, pressure P₁ is provided to tube 2, leading to the generation of air bubbles at section B of the tube. Given the fact that at section A no air bubbles are generated, a circulating flow will created in the water. This flow constantly agitates the wool. While being agitated, the air bubbles are led through the greasy wool and remove impurities present to the surface of the container. There, the air bubbles and attached impurities are skimmed of by hand. This process takes about 10 minutes. After that, the wool is removed from the container and (at least substantially) dried. The lanolin is removed from the dried wool by extraction with regular ethyl alcohol. After extraction, the wool is centrifuged and dried to remove any residual water and alcohol. The lanolin is separated from the alcohol by evaporation of the alcohol.

The resulting wool is clean and has no stable-odor, at least not noticeable by a human subject with average olfaction. The lanolin is in the form of anhydrous lanolin, with no apparent signs of impurities such as water, soluble lanolin alcohols, salts, vegetable matter etc.

### EXAMPLE 2

Example 2, in conjunction with FIG. 2, shows a production facility 10 for souring wool in line with the current invention. This facility comprises five separate bowls to perform various stages of the wool scouring process. The first bowl 11 contains water at a temperature of about 20° C. This bowl is used for wetting the wool. The wool is simply soaked in the water for about 15 minutes. After that, the wool is passed through pressure rollers 12, in order to remove substantially all water from the wool (which water is recycled through the use of recycle tubing 13 to bowl 11), and passed over to the second bowl. This bowl 21 is a flotation bowl which comprises water with a temperature of about 20°. The bowl is provided with multiple jet pipes 26 and skimmers 27. The jet pipes are used for jetting water containing fine air bubbles into the bowl during the flotation process. This provides the required air bubbles for cleaning the wool and a flow in the water that constantly agitates the wool. The skimmers 27 are used to skim of the air bubbles with attached impurities. After about 15 minutes, the wool is passed through pressure rollers 22, in order to remove substantially all water from the washed wool (which water is recycled through the use of recycle tubing 23 to bowl 21), and passed over to the third bowl. This bowl 31 is a bowl that is used for the extraction of lanolin by solvent extraction. The bowl contains alcohol. To separate the lanolin from the wool may take approximately 5 minutes. The solvent containing lanolin is constantly refreshed by dosing new (recycled) solvent into the bowl (tubing not shown) and extracting solvent containing lanolin (tubing not shown) which makes this bowl the extraction equivalent of a continuously stirred tank reactor (CSTR). After the lanolin is separated from the wool, the wool is passed through pressure rollers 32, in order to remove substantially all solvent from the wool (which solvent is recycled through the use of recycle tubing 33 to bowl 31), and passed over to the fourth bowl. This bowl 41 is used for the enzymatic treatment of the wool in order to reduce its tendency to alter under the influence of UV radiation. This bowl contains water at about 40° C. and a modified (sterically enlarged) Esperase (EC 3.4.21.62; see the Smith reference as noted supra) at 25U/ml. The time needed for the enzyme to remove the UV sensitive proteins from the wool is about 40 minutes. After that, the wool is passed through pressure rollers 42, in order to remove substantially all water from the wool (which water is recycled through the use of recycle tubing 43 to bowl 41), and passed over to the fifth and last bowl. This bowl 51 is used for removing the residual proteases from the wool and possible remains of the proteins removed from the wool. The water has a temperature of about 40° C., and typically contains a low concentration of detergent. The washing typically takes 5-15 minutes. After that, the wool is passed through pressure rollers 52, in order to remove substantially all water from the wool (which water is recycled through the use of recycle tubing 53 to bowl 51). The wool is thereafter dried and baled.

The solvent containing lanolin as extracted from bowl 31 is distilled to separate the lanolin form the solvent. The clean solvent is then recycled to bowl 31 as described here-above.

What is claimed is:

1. method to wash wool containing lanolin and impurities, comprising the steps of:
providing a volume of an aqueous liquid at a temperature below a melting temperature of the lanolin,
soaking the wool in the volume of the liquid,
creating air bubbles in the liquid and allowing the air bubbles to pass through the wool to attach the impurities,
removing the wool from the said volume.

2. A method according to claim 1, wherein the step of soaking the wool includes soaking the wool in the volume of liquid for 1 to 60 minutes, before the air bubbles are allowed to pass through the wool.

3. A method according to claim 1, further comprising the step of removing the air bubbles and attached impurities from the volume while the wool is being washed, by skimming off the said bubbles when having reached a surface of the said volume of the liquid.

4. A method according to claim 1, wherein the wool is agitated when the air bubbles pass through the wool.

5. A method according to claim 4, further comprising the step of imposing a flow in the liquid to agitate the wool.

6. A method according to claim 5, wherein the step of imposing a flow includes imposing the flow in the liquid by the creation of the air bubbles.

7. A method according to claim 1, wherein the step of creating the air bubbles in the liquid includes ejecting a liquid containing air bubbles in the volume using an ejection nozzle.

8. A method according to claim 1, further including, after washing the wool, the step of removing the lanolin from the wool.

9. A method according to claim 8, further including the step of treating the wool with a protease after the lanolin is removed.

10. A method to separate lanolin from wool containing lanolin and impurities, comprising the steps of:
providing a volume of an aqueous liquid at a temperature below a melting temperature of the lanolin,
soaking the wool in the volume of the liquid,
creating air bubbles in the liquid and allowing the air bubbles to pass through the wool to attach the impurities, leaving the lanolin on the wool, and thereafter
separating the lanolin from the wool.

11. A method according to claim 10, wherein the step of separating the lanolin from the wool is performed by solvent extraction.

12. A method according to claim 11, further including the step of removing the wool from the volume of liquid, before the lanolin is extracted from the wool.

13. A method according to claim 11, further including the step of separating the lanolin from the solvent by evaporation of the solvent.

14. Wool obtainable by using the method of claim 1.

15. Lanolin obtainable by the method of claim 10.

16. A method according to claim 2, wherein the step of soaking the wool includes soaking the wool in the volume of liquid for 10 to 40 minutes, before the air bubbles are allowed to pass through the wool.

17. A method according to claim 12, further including the step of drying the wool and after removing the wool from the volume of liquid before the lanolin is extracted from the wool.

18. A method according to claim 13, wherein the step of separating the lanolin from the solvent by evaporation of the solvent, is performed using a distillation process.

19. Wool obtainable by using the method of claim 10.
